(19) United States
(12) Patent Application Publication
(10) Pub. No.: US 2015/0268125 A1
(43) Pub. Date: Sep. 24, 2015

(54) OIL DETECTION SENSOR MODULE FOR SENSING OIL LEAKAGE IN COOLANT SYSTEM

(71) Applicant: Caterpillar Inc., Peoria, IL (US)

(72) Inventor: Bradley J. Read, Delphi, IN (US)

(73) Assignee: Caterpillar Inc., Peoria, IL (US)

(21) Appl. No.: 14/730,304

(22) Filed: Jun. 4, 2015

(51) Int. Cl. G01M 3/28

(52) U.S. Cl. CPC G01M 3/28

(57) ABSTRACT

An oil detection sensor module for sensing oil leakage in a coolant system is provided. The oil detection sensor module includes a body, a membrane, and a sensor. The body includes a first end and a second end, which define a chamber. The membrane is disposed at the first end of the body. The sensor is sealably coupled to the second end of the body. A sensing end of the sensor is disposed in the second end of the body. The sensing end is arranged to detect oil in the chamber. The oil entrained in the coolant is in fluid communication with the sensor through the membrane. The membrane restricts the passage of water-soluble products through the membrane. Upon detection of a threshold level of the oil in the chamber, an alarm is signaled, via the sensor.

### TECHNICAL FIELD

The present disclosure relates to a sensor system for detecting degradation of coolant in a coolant system. More particularly, the present disclosure relates to an oil detection sensor module for sensing oil leakage in a coolant system.

### BACKGROUND

Engines may be equipped with coolant systems to cool certain components of therein to ensure proper performance. For example, a coolant system for use with the engine is well known. The coolant system typically includes passages which are adjacent to the lubrication system to ensure that the coolant draws heat away from the lubricant for proper cooling

However, if the barrier between the oil and coolant, which may consist of a steel casting wall in the engine block or a seal between these two systems, for example, fails, then the oil may mix with the coolant. This, in turn, may result in the oil mixing with the coolant. The byproducts of this mixture often settle in the coolant tank. If the condition of the coolant is not regularly checked then the oil in the coolant and thus coolant in the oil within the lubrication system could damage the engine or even completely destroy the engine and coolant systems. Therefore, having the ability to ascertain whether oil is mixing with the coolant when such a situation occurs or shortly thereafter, can mitigate further damage and protect the engine and coolant system from further damage.

U.S. Pat. No. 7,043,967 discloses an apparatus that provides a method to monitor the condition of the coolant as well as detect abnormal operating conditions. This reference pertains to the detection of contaminants by use of fluid sampling, via a plurality of sensors. However, this arrangement may be unfavorable since coolant tanks are generally positioned at distant locations. Frequent fluid sampling may be impractical due to the remote location of the coolant tanks, coolant tank design, lack of maintenance personnel, and/or operational cost of a coolant analysis system. Hence, it is desirable to develop a more convenient and cost effective method for the detection of contaminants in the coolant tanks.

### SUMMARY OF THE INVENTION

Various aspects of the present disclosure describe an oil detection sensor module to sense oil leakage in a coolant system. The oil detection sensor module includes a body, a membrane, and a sensor. The body includes a first end and a second end. A chamber is disposed between the first end of the body and the second end of the body. The membrane is disposed at the first end of the body. The membrane is structured and arranged to filter oil into the chamber of the body and to reject entrance of the coolant into the body. The sensor includes a sensing end and a housing end. The sensor is sealably coupled to the second end of the body. The sensing end of the sensor is disposed in the second end of the body. The sensing end is arranged to detect the oil in the chamber. The oil entrained in the coolant is in fluid communication with the sensor. The membrane restricts the passage of water-soluble products, in response to at least partial submersion of the oil detection sensor module in the coolant. Upon detection of a threshold level of the oil in the chamber, an alarm is signaled, via the sensor.

### BRIEF DESCRIPTION OF THE DRAWINGS

FIG. 1 is a schematic of an oil detection system for a coolant tank, in accordance with the concepts of the present disclosure;

FIG. 2 is a perspective view of a first embodiment of an oil detection sensor module of the oil detection system of FIG. 1, depicting oil captured in a central portion therein, in accordance with the concepts of the present disclosure;

FIG. 3 is a sectional view of the oil detection sensor module of FIG. 2, in accordance with the concepts of the present disclosure;

FIG. 4 is a perspective view of a second embodiment of the oil detection sensor module of the oil detection system of FIG. 1, in accordance with the concepts of the present disclosure;

FIG. 5 is a sectional view of the oil detection sensor module of FIG. 4, in accordance with the concepts of the present disclosure; and

FIG. 6 is a perspective view of a third embodiment of the oil detection sensor module of the oil detection system of FIG. 1, with portions of the body removed to more clearly display a membrane and a sensor, in accordance with the concepts of the present disclosure.

### DETAILED DESCRIPTION

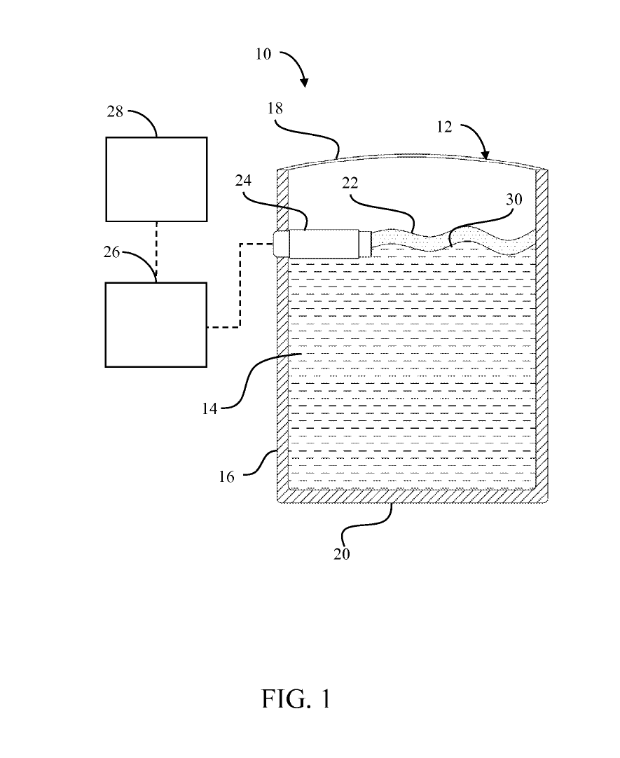

Referring to FIG. 1, there is shown an oil detection system 10 for a coolant tank 12. The coolant tank 12 is provided to store a coolant 14 or water soluble mixture 14, which is communicated to an engine system (not shown) to cool the engine as is customary. Generally, the coolant 14 is a mixture of water and glycol. The coolant tank 12 includes a lateral wall 16, a cover portion 18, and a bottom portion 20. The coolant tank 12 is provided with the oil detection system 10, to detect the presence of the oil 22 in the coolant 14.

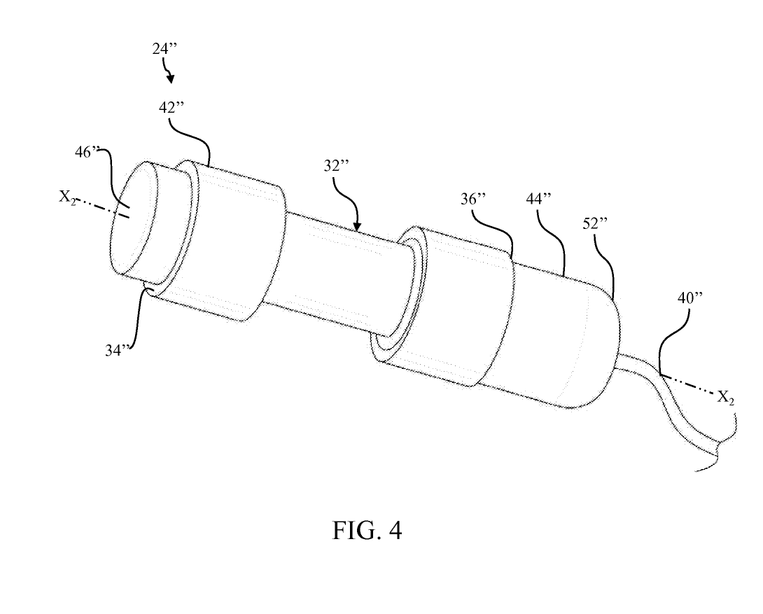

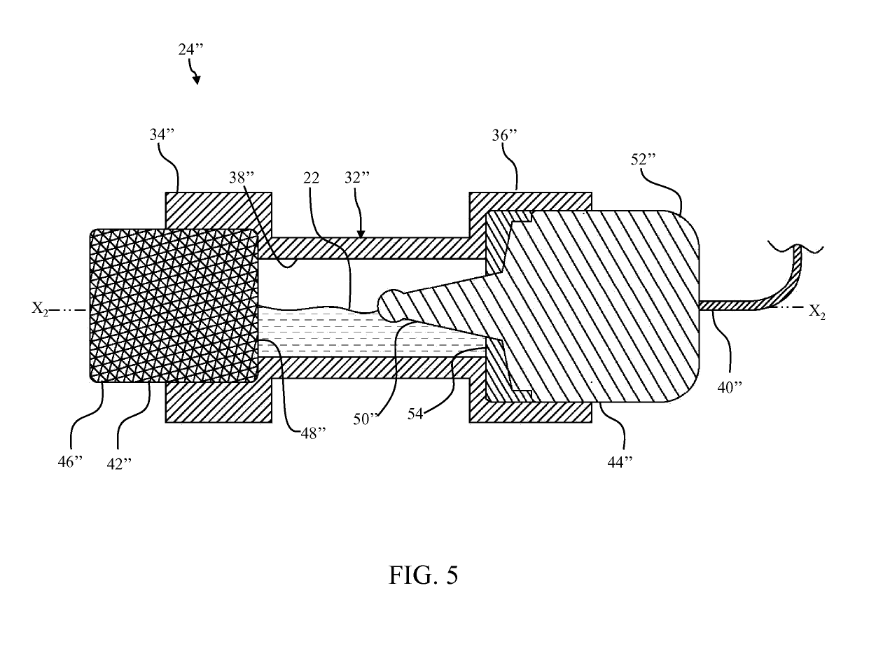

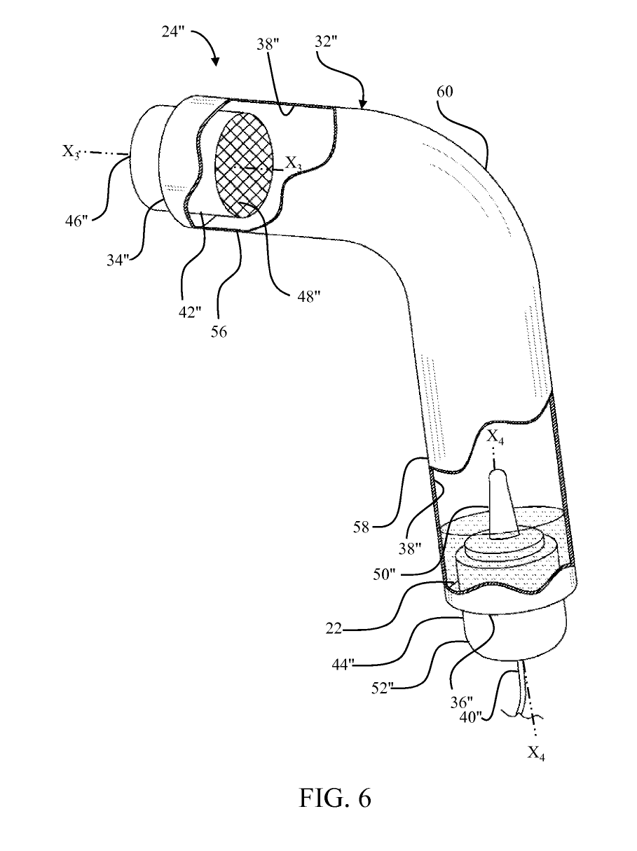

The oil detection system 10 includes an oil detection sensor module 24, a processor 26, and an alarm circuit 28. The oil detection sensor module 24 may embody various structural forms, such as an oil detection sensor module 24 (shown in FIGS. 4 and 5) and an oil detection sensor module 24′ (shown in FIG. 6). Referring now to FIG. 1, the oil detection sensor module 24 may be attached proximal to the cover portion 18. In such case, the oil 22 which typically resides at a surface 30 of the coolant 14 due to the relative specific gravity of the oil 22 relative to the coolant 14, has had at least a portion of the oil 22 enter the oil detection sensor module 24 (see FIG. 5, specifically the oil 22). The oil detection sensor module 24 may be positioned to float on the surface 30 of the coolant 14 within the coolant tank 12. In such cases, the oil detection sensor module 24 may tend to move from side-to-side due to coolant motion. This may permit the entrance of the oil 22 in the coolant 14.

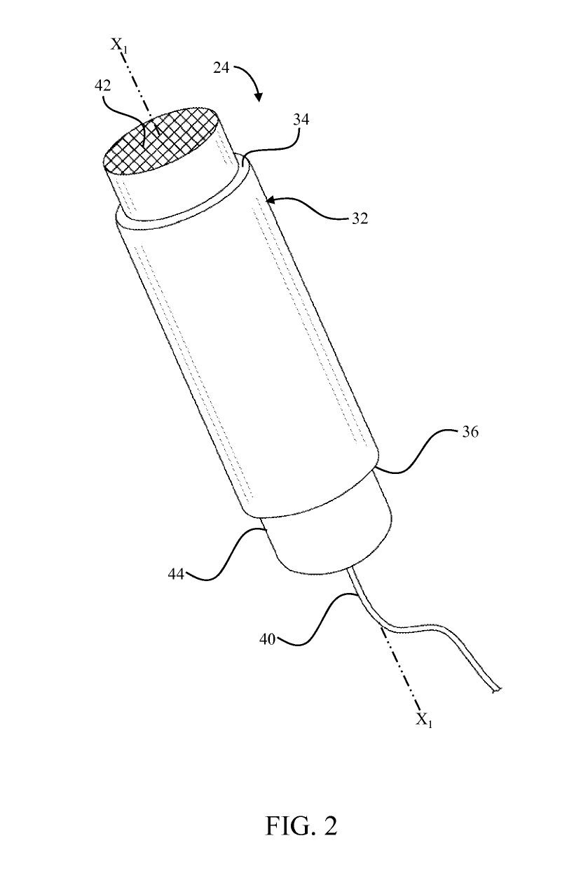

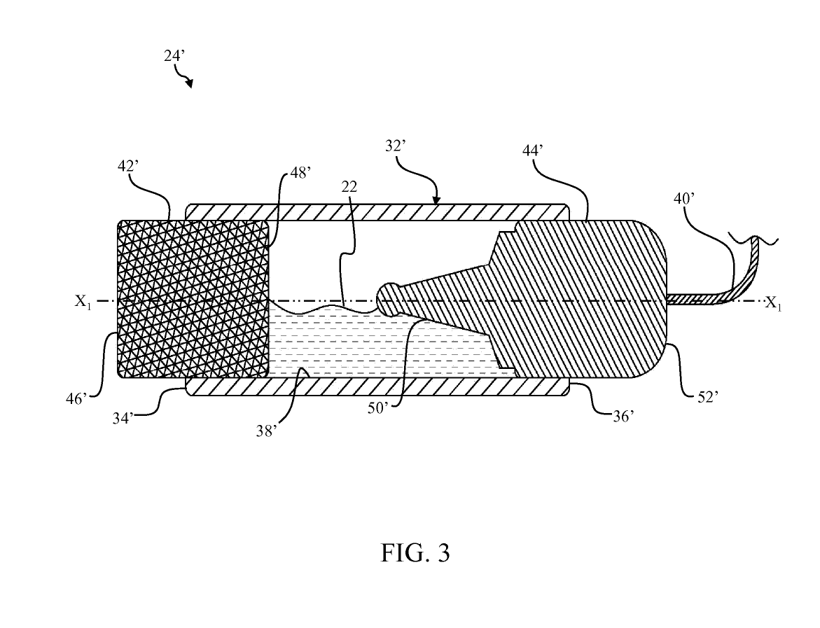

Referring to FIG. 2, there is shown the oil detection sensor module 24, which is a first embodiment of the oil detection sensor module 24. The oil detection sensor module 24 includes a body 32, which is aligned along a first longitudinal axis (X₁-X₁). The body 32 includes a first end 34 and a second end 36. Between the first end 34 and the second end 36, a chamber 38 (FIG. 3) is defined. The second end 36 of the body 32 is structured and arranged to detect the oil 22 in the chamber 38. The second end 36 may be in communication with the processor 26 (FIG. 1), via a wire 40.

Referring to FIGS. 2 and 3, the oil detection sensor module 24 includes a membrane 42 and a sensor 44. The membrane 42 is housed within the first end 34 of the body 32 of the oil detection sensor module 24, and is aligned along the first longitudinal axis (X₁-X₁). The membrane 42 may be a permeable membrane, a hydrophobic membrane, a ceramic membrane, or any other membrane known to those having ordinary skill, which accepts the oil 22 to pass through and restricts the coolant 14 from entering the membrane. Therefore, the membrane 42 rejects transmission of water-soluble liquids such as coolant 14, but provides for the transmission of the oil 22. These membranes are relatively well known and may be constructed with a pre-determined pore radius to allow the oil 22 to pass through. The membrane 42 extends into the first end 34 of the oil detection sensor module 24, such that the membrane 42 is sealed about the first end 34. The oil detection sensor module 24 is engaged with the second end 36. The membrane 42 includes an entry end 46 and an exit end 48. The entry end 46 is placed external relative to the first end 34. In addition, the exit end 48 is generally sealed within the chamber 38 of the oil detection sensor module 24. The oil 22 enters the entry end 46 and thereafter is retained with the chamber 38.

The sensor 44 is sealed within the second end 36 of the body 32. The sensor 44 includes a sensing end 50 and a housing end 52. The sensing end 50 extends from the second end 36 towards the chamber 38. The sensing end 50 may be made to float within the coolant tank 12 (FIG. 1) so that the oil 22, which typically floats on the surface 30 of the coolant 14 will come into contact with the membrane 42. The sensing end 50 of the sensor 44 is shaped and arranged to detect a threshold level of the oil 22 captured in the chamber 38. In the exemplary embodiment, the sensing end 50 is characterized with a substantially conical shape. The housing end 52 is opposed to the sensing end 50. The housing end 52 extends from the second end 36 away from the chamber 38. The housing end 52 is provided with the wire 40, which may communicate an output to the processor 26 (FIG. 1). The processor 26 is in connected to the alarm circuit 28.

Referring to FIG. 4, there is shown the oil detection sensor module 24′, which is a second embodiment of the oil detection sensor module 24. The oil detection sensor module 24′ includes a body 32′, a membrane 42′, a sensor 44′, and a sealing element 54. The body 32′ is nearly cylindrical in shape and is aligned along a second longitudinal axis (X₂-X₂). The body 32′ includes a first end 34′, a second end 36′, and a chamber 38′ (FIG. 5). The first end 34′ and the second end 36′ may be characterized with equal diameter. The second end 36′ may be in communication with the processor 26 (FIG. 1), via a wire 40′.

Referring to FIG. 5, there is shown a cross-section view of the oil detection sensor module 24′. The chamber 38′, the membrane 42′, and the sensor 44′ are aligned along the first longitudinal axis (X₂-X₂). The chamber 38′ is defined between the first end 34′ and the second end 36′. Downstream of the first end 34′, diameter of the body 32′ decreases until the second end 36′, to define the chamber 38′ with a narrow diameter as compared to the diameter of the first end 34′ and the second end 36′.

The membrane 42′ is housed in the body 32′ of the oil detection sensor module 24′. The membrane 42′ is similar to the membrane 42 (FIG. 2) in composition and structure. The membrane 42′ restricts the passage of water-soluble compounds and allows transmission of the oil 22, therethrough. The membrane 42′ is sealed in the first end 34′ of the oil detection sensor module 24′, such that the membrane 42′ is sealably secured in the first end 34′. The membrane 42′ includes an entry end 46′ and an exit end 48′, which are substantially equal in diameter. The entry end 46′ is placed external relative to the first end 34′. In addition, the exit end 48′ extends from the first end 34′ and is housed in the chamber 38′. The oil 22, which is transmissible via the entry end 46′, gets collected into the chamber 38′.

The sensor 44′ is positioned proximal to the chamber 38′. The sensor 44′ is sealably attached to the second end 36′ of the body 32′. The sensor 44′ includes a sensing end 50′ and a housing end 52′. The sensor 44′ is sealed in the second end 36′ in such a way that the sensing end 50′ is positioned in the chamber 38′ and the housing end 52′ is positioned external to the chamber 38′. The sensing end 50′ is structured to be in contact with the transmitted oil 22, which is accumulated in the chamber 38′. The sensing end 50′ is functional to detect the threshold level of the oil 22, which are collected in the chamber 38′. The sensing end 50′ is housed in a sealing element 54, which is placed at the second end 36′ of the oil detection sensor module 24′. The sealing element 54 is proximal to the chamber 38′ and is structured to complement the shape of the sensing end 50′ of the sensor 44′. The sensor 44′ may be connected to a power source via the wire 40′, which is connected to the housing end 52′ of the sensor 44′. On being powered via the wire 40′, the sensor 44′ operates to detect the oil 22 in the coolant 14. The detection may be communicated as an output to the processor 26 (FIG. 1).

Referring to FIG. 6, there is shown the oil detection sensor module 24″, which is a third embodiment of the oil detection sensor module 24. The oil detection sensor module 24″ includes a body 32″, a membrane 42″, and a sensor 44″. The body 32″ is an elbow-shaped structure. The body 32″ includes a first end 34″, a second end 36″, and a chamber 38″. The first end 34″ and the second end 36″ are shown via cut-out portions in FIG. 6, to depict the position of the sensor 44″ and the membrane 42″. The first end 34″ and the second end 36″ are substantially equal in diameter. The first end 34′″ is aligned along a third longitudinal axis (X₃-X₃). The second end 36″ is aligned along a fourth longitudinal axis (X₄-X₄). The chamber 38″ is defined between the first end 34″ and the second end 36″. The chamber 38″ includes a first portion 56, a second portion 58, and a curved portion 60. The first portion 56 and the second portion 58 are substantially cylindrical in shape. The first portion 56 is proximal to the first end 34″ and the second portion 58 is proximal to the second end 36″. The curved portion 60 is defined between the first portion 56 and the second portion 58. The oil detection sensor module 24″ is arranged on the lateral wall 16 of the coolant tank 12, in such a way that the first end 34″ is directed towards an interior of the coolant tank 12. The second end 36″ of the body 32″ is structured and arranged to detect the oil 22 in the chamber 38″. The sensor 44″ is powered via a wire 40″, which may be in communication with the processor 26 (FIG. 1).

The membrane 42″ is housed within the body 32″ of the oil detection sensor module 24″. The membrane 42″ is similar to the membrane 42′ and the membrane 42, in structure and composition. The membrane 42″ includes an entry end 46″ and an exit end 48″, which are equal in diameter. The membrane 42″ is sealed in the first end 34″ in such a way that the entry end 46″ is placed externally relative to the first end 34″, while the exit end 48″ is within the chamber 38″.

The sensor 44″ includes a sensing end 50″ and a housing end 52″. The sensor 44″ is sealably attached to the second end 36″ such that the sensing end 50″ is within the chamber 38″ and the housing end 52″ is external relative to the chamber 38″. The sensing end 50″ is structured to be in contact with the transmitted oil 22, which is accumulated in the chamber 38″. The sensing end 50″ detects the threshold level of the oil 22 collected in the chamber 38″. The housing end 52″ is connected to the wire 40″, such that the sensor 44″ may be powered via the power source. The sensor 44″ is powered to detect the oil 22 in the coolant 14, which in turn is communicated to the processor 26 (FIG. 1). The processor 26 is in control communication with the alarm circuit 28.

### INDUSTRIAL APPLICABILITY

In operation, some vaporized oil may leak from the oil passages of a machine or an engine and pass into the coolant passages, over a period. Further, the vaporized oil, which is denoted as the oil 22, may pass into the coolant tank 12. The oil detection sensor modules 24, 24′, and 24″ of the oil detection system 10 are positioned in the coolant tank 12 to detect the presence of the oil 22 in the coolant 14. In an embodiment, the oil detection sensor modules 24, 24′, and 24″ may float on the surface 30. As a result, the oil detection sensor modules 24, 24′, and 24″ may move due to the coolant motion in the coolant tank 12. The selective transmissibility of the membranes 42, 42′, and 42″ of the oil detection sensor modules 24, 24′, and 24″, restrict entry of the coolant 14 into the chambers 38, 38′, and 38″. In response to a submersion of the oil detection sensor modules 24, 24′, and 24″, the oil 22 passes through the membranes 42, 42′, and 42″ and is accumulated in the chambers 38, 38′, and 38″. The sensing ends 50, 50′, and 50″ within the chambers 38, 38′, and 38″ come in contact with the oil 22 accumulated in the chambers 38, 38′, and 38″. The sensors 44, 44′, and 44″ are powered by the power source (not shown), via the wire 40, 40′, and 40″, respectively. On being powered, the sensors 44, 44′, and 44″ operate to detect the presence of the oil 22 in the coolant 14. The sensing ends 50, 50′, and 50″, respectively, are in contact with the oil 22 in the chambers 38, 38′, and 38″. Thereafter, the sensors 44, 44′, and 44″ detect the presence of the oil 22, when the threshold level of the oil 22 collects in the chambers 38, 38′, and 38″. Upon detection of the oil 22, the sensors 44, 44′, and 44″ generate an oil detection signal and deliver the oil detection signal to the processor 26. The processor 26 then analyses the oil detection signal received and transmits an alarm signal to the alarm circuit 28. The alarm circuit 28, in turn, activates an audible alarm to warn a nearby operator that the oil 22 is detected in the coolant 14.

The present disclosure further contemplates that the processor 26 may be in communication with other devices such as a hand held mobile devices or a remotely located computer to notify an information receiver that the oil 22 is detected in the coolant 14.

The disclosed oil detection sensor modules 24, 24′, and 24″ serve the purpose of oil detection in the coolant tank 12. As the presence of the threshold level of the oil 22 is detected, instant detection of the oil 22 is performed by the sensors 44, 44′, and 44″. It is generally sufficient to merge the sensing ends 50, 50′, and 50″ of the sensors 44, 44′, and 44″, respectively, with only a thin layer of the oil 22 to provide detection. In addition, the sensors 44, 44′, and 44″ may be sealably positioned at different angles within the chambers 38, 38′, and 38″, at the second ends 36, 36′, and 36″, respectively. This permits accumulation of a pre-determined quantity of the oil 22, prior to detection. Thus, an irrelevant detection of the oil 22 by small amounts of the oil 22 is prevented. Hence, chances of failure of the coolant tanks due to oil and resulting byproduct formations are reduced. Further, extensive cleaning of tank may not be required at as frequent of intervals. The shapes and sizes of the body 32, 32″, 32′″, the sensor 44, 44″, 44′″, and the membrane 42, 42″, 42′″ are exemplary in nature and do not restrict the disclosure to the specific geometries illustrated, herewith.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. An oil detection sensor module for sensing oil leakage in a coolant system, the oil detection sensor module comprising:
a body having a first end and a second end, and a chamber disposed between the first end of the body and the second end of the body;
a membrane disposed within the first end of the body, wherein the membrane is structured and arranged to receive oil into the chamber of the body and prevent coolant from entering the body; and
a sensor having a sensing end and a housing end, the sensor sealably coupled to the second end of the body, wherein the sensing end of the sensor being disposed in the second end of the body and structured and arranged to detect oil in the chamber,
wherein the oil entrained in the coolant being in fluid communication with the sensor through the membrane and water soluble products being restricted from passing through the membrane in response to at least partial submersion of the oil detection sensor module in the coolant,
wherein an alarm is being signaled when a threshold level of the oil in the chamber is detected, via the sensor.
